(19) United States
(12) Patent Application Publication
(10) Pub. No.: US 2007/0137412 A1
(43) Pub. Date: Jun. 21, 2007

(54) Vehicle steering wheel

(76) Inventors: Mats Johansson, Orebro (SE); Ola Pihlgren, Stockholm (SE); Sara Westermark, Stockholm (SE); Teddy Karlsson, Holo (SE)

Correspondence Address: OSTROLENK FABER GERB & SOFFEN, 1180 AVENUE OF THE AMERICAS, NEW YORK, NY, 100368403, US

(21) Appl. No.: 10/582,032

(22) PCT Filed: Nov. 29, 2004
(86) PCT No.: PCT/SE04/01765

§ 371 Date: Aug. 8, 2006

(30) Foreign Application Priority Data
Dec. 9, 2003 (SE) 0303299-2

(51) Int. Cl. B62D 1/04

(52) U.S. Cl. 74/552

(57) ABSTRACT

A vehicle steering wheel comprising a rim, a signal cap and two upper and two lower spokes extending between the rim and the signal cap, the upper spokes extending along the horizontal symmetry axis of the steering wheel towards its centre. The two lower spokes are graspable by a normal man's hand. The lower spokes extend from positions around the rim so that points P1, P2 that are in line with the upper edge of the respective lower spokes on the outer surface of the rim are located between 30° and 60° below the horizontal symmetry axis on either side of the vertical symmetry axis of the steering wheel. The upper edge of the lower spoke, which is in line with the respective points P1, P2 form an angle (β) of between 62° and 82° with the vertical symmetry axis.

### TECHNICAL FIELD

The invention relates generally to vehicles and more specifically to steering wheels for vehicles, particularly trucks.

### BACKGROUND OF THE INVENTION

US 2002/0125698 A1 discloses a steering wheel with two upper and two lower spokes. Multifunctional switch modules with control buttons for remote actuation of specific vehicle functions are located between the upper and the lower spokes along an air bag module.

For a driver that often drives long hours it is very important to have a good and ergonomic driving position in order to avoid discomfort and tension in the muscles. A driver using the steering wheel in US 2002/0125698 A1 cannot for instance fit his/her hands around the lower spokes, which give an ergonomic position for the hands when driving long distances. It is not easy to access the control buttons without moving the hands from a resting position.

Since truck drivers tend to rest their arms on the steering wheel while driving, a control button may unintentionally be pressed on a steering wheel of the type disclosed in US 2002/0125698 A1.

Moreover, since steering wheels for trucks are large and the drivers want to have a clear view of the instrument panel through the steering wheel, the distance to the control buttons at a steering wheel in accordance with US 2002/0125698 A1 in a truck would be too great.

Thus, the steering wheel according to US 2002/0125698 A1 is not particularly user-friendly and ergonomic.

### SUMMARY OF THE INVENTION

The object of the invention is to provide a more user-friendly and ergonomic steering wheel, particularly for trucks, giving the driver a good driving position.

Another object is to provide a steering wheel at which the risk for the driver to unintentionally touch a control button on the steering wheel is minimized.

At a vehicle steering wheel according to the invention that comprises a rim, a signal cap and two upper and two lower spokes that extend between the rim and the signal cap, the upper spokes extending along the horizontal symmetry axis of the steering wheel towards the centre of the steering wheel, this is attained in that the two lower spokes are graspable, that the two lower spokes extend from positions around the rim that are located between 30° and 60° below the horizontal symmetry axis on either side of the vertical symmetry axis of the steering wheel, and that the lower spokes form an angle of between 62° and 82° with the vertical symmetry axis of the steering wheel.

By making the lower spokes graspable at least for a normal man's hand, i.e. forming them as handles, a good driving position for the driver will be enabled. Since particularly truck drivers sit many hours in the truck every day, grasping the lower spokes now and then will be a good alternative to holding on to the rim of the steering wheel or grasping the upper spokes.

Preferably, the lower spokes extend from positions around the rim at 40° below the horizontal symmetry axis of the steering wheel on either side of the vertical symmetry axis of the steering wheel.

Preferably, the lower spokes form an angle of between 67° and 77°, particularly 72°, with the vertical symmetry axis of the steering wheel.

It has been found that an inclination of the lower spokes of 72° relative to the vertical symmetry axis of the steering wheel is more or less optimal for the driver.

Preferably, a multifunctional switch module with thumb-operated control buttons for remote actuation of specific vehicle functions is located symmetrically between the two lower spokes on the steering wheel beneath the signal cap.

By placing the multifunctional switch module symmetrically between the two lower spokes beneath the signal cap, it will be easy for the driver to operate the buttons with his thumbs while grasping the lower spokes without moving his eyes from the road. When doing this the driver can hold his/her hands in a restful position without having to bend the wrists in unpleasant angles.

Preferably, the lower spokes are separated from the upper spokes by spaces for receiving a driver's elbows.

Hereby, it will be possible for a truck driver to rest his arms at temporary stops without running the risk of unintentionally pressing a control button on the multifunctional switch module.

### BRIEF DESCRIPTION OF THE DRAWING

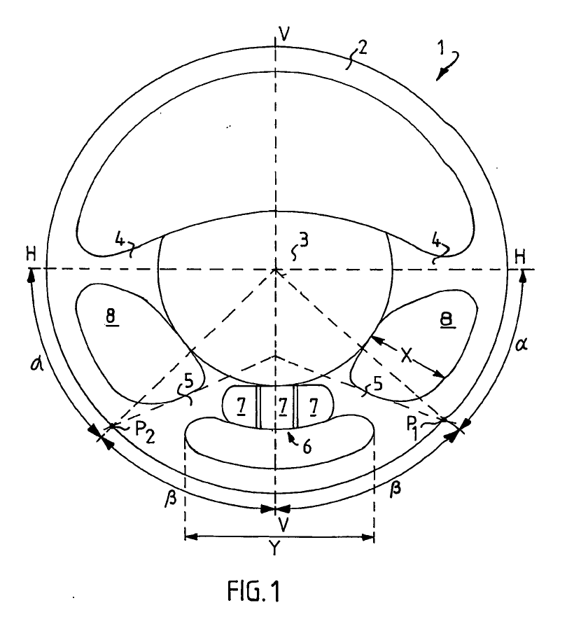

The invention will be described more in detail below with reference to the appended drawing on which FIG. 1 is a plan view of an embodiment of a vehicle steering wheel according to the invention.

### DESCRIPTION OF THE INVENTION

FIG. 1 is a plan view of an embodiment of a vehicle steering wheel 1 according to the invention.

As most of today's steering wheels, the steering wheel 1 comprises a rim 2, a signal cap 3, and two upper spokes 4 and two lower spokes 5 between the rim 2 and the signal cap 3. In a manner known per se, the upper spokes 4 extend along the horizontal symmetry axis H-H of the steering wheel 1 towards its centre.

In accordance with the invention, the two lower spokes 5 are graspable, i.e. formed as handles to be grasped by a driver's hands. The graspable part of the upper edge of the lower spokes 5 has room for a normal man's hand. The width X of the graspable part of upper edge of the lower spokes is preferably 85 mm±20 mm.

To provide a good and relaxed driving position for the driver, particularly a truck driver, in accordance with the invention, the lower spokes 5 extend from positions around the rim 2 that are located α° below the horizontal symmetry axis H-H of the steering wheel 1 on either side of the vertical symmetry axis V-V of the steering wheel 1, and, moreover, the lower spokes 5 are oriented such that they form an angle of β° with the vertical symmetry axis V-V of the steering wheel 1. Points P₁, P₂ on the outer surface of the rim 2 on either side of the vertical symmetry axis V-V, that is in line with the upper edge of respective lower spoke are located α° below the horizontal symmetry axis H-H of the steering wheel 1 on either side of the vertical symmetry axis V-V of the steering wheel 1. Moreover points P₁, P₂ are located such that a line from respective point in line with the upper edge of respective lower spoke form β° with the vertical symmetry axis V-V of the steering wheel 1.

The angle α is between 30° and 60°, preferably 40°, and the angle β is between 62° and 82°, preferably between 67° and 77°, and specifically 72°.

By giving the lower spokes 5 such an inclination at such positions, it will be natural for the driver to grasp the lower spokes 5 while driving. It will also give an ergonomic driving position which minimizes the need to bend the wrists in uncomfortable and tiring positions.

Also in accordance with the invention, a multifunctional switch module 6 with thumb-operated control buttons 7 for remote actuation of frequently used specific vehicle functions such as cruise control, downhill speed control and control of an information display, is located symmetrically between the two lower spokes 5 beneath the signal cap 3.

It is to be understood that other thumb-operated control buttons (not shown) can be symmetrically located in the upper spokes 4 of the steering wheel for actuation by the driver of other frequently used functions in a truck such as different radio functions with his hands grasping the upper spokes 4.

In FIG. 1, three control buttons 7 are shown on the multifunctional switch module 6. It is however to be understood that the number of control buttons 7 is in no way restricted to three.

By locating the multifunctional switch module 6 between the two lower spokes 5, the truck driver will be able to operate the control buttons 7 with his thumbs while grasping the lower spokes 5 with his hands without moving his eyes from the road.

To enable the driver to operate the control buttons 7 with both his thumbs, the control buttons 7 of the multifunctional switch module 6 are located symmetrically relative to the vertical symmetry axis of the steering wheel 1 as illustrated in FIG. 1.

To enable the driver to rest his arms on the steering wheel 2, particularly at temporary stops, e.g. at traffic lights, the lower spokes 5 are separated from the upper spoke 4 by spaces 8 that are large enough for receiving the driver's elbows. Moreover, the spaces 8 are large enough to give the driver a clear view to instruments behind the steering wheel 1 while driving.

As should be apparent from the above, the steering wheel according to the invention is user-friendly, offers great comfort to the driver, and is “safe” in that the driver can operate control buttons on the steering wheel without moving his eyes from the road.

The lower part of the rim is also graspable and the driver may grasp it by both of his/her hands. The width Y of this graspable part is 200±20 mm and the distance between the switch module and the rim is approximately 45 mm.

An outer diameter of the steering wheel of about 450 mm will give a steering wheel with good manoeuvrability of the vehicle.

1. A vehicle steering wheel comprising
a rim, a signal cap inside the rim
two upper spokes extending between the rim and the signal cap, the upper spokes extending along a horizontal symmetry axis (H-H) of the steering wheel towards a center of the wheel;
two lower spokes also extending between the signal cap and the rim, the lower spokes having an upper edge;
two lower spokes also extending between the signal cap and the rim, the lower spokes having an upper edge;
the two lower spokes are shaped and positioned to be graspable by a normal man's hand, the lower spokes extend from positions around the rim so that points P₁, P₂ that are in line with the upper edge of the respective lower spokes on the outer surface of the rim are located between 30° and 60° below the horizontal symmetry axis on either side of the vertical symmetry axis of the steering wheel, and the upper edge of the lower spokes is in line with the respective points P₁, P₂ and forms an angle (β) of between 62° and 82° with the vertical symmetry axis (V-V) of the steering wheel, and
a multifunctional switch module including control buttons operable for remote actuation of vehicle functions, the module is located between the two lower spokes beneath the signal cap, whereby the driver can operate the module while grasping the lower spokes.

2. The steering wheel according to claim 1, wherein the two points P₁, P₂ are situated 40° below the horizontal symmetry axis (H-H) on either side of the vertical symmetry axis of the steering wheel.

3. The steering wheel according to claim 2, wherein the angle (β) from the vertical symmetry axis of the steering wheel to the respective points P₁, P₂ are between 67° and 77°.

4. The steering wheel according to claim 3, wherein the angle (β) is 72°.

5. The steering wheel according to claim 1, wherein the lower spokes are separated from the upper spokes by spaces shaped to be able to receive a driver's elbows.

6. The steering wheel according to claim 1, wherein a width of the graspable part of the upper edge of the lower spokes is between 65 mm and 105 mm.

7. The steering wheel according to claim 6, wherein the width of the graspable part of the upper edge of the lower spokes is approximately 85 mm.

8. The steering wheel according to claim 1, wherein the module is located symmetrically between the two lower spokes.
